(19) United States
(12) Patent Application Publication
(10) Pub. No.: US 2006/0053974 A1
(43) Pub. Date: Mar. 16, 2006

(54) Coupling for a surgical rotary drive hand piece

(75) Inventors: Edgar Blust, Koenigsfeld (DE); Thomas Mueller, Bellach (CH)

Correspondence Address: Lipsitz & McAllister, LLC, 755 MAIN STREET, MONROE, CT, 06468, US

(73) Assignee: AESCULAP AG & Co. KG, Tuttlingen (DE)

(21) Appl. No.: 11/226,192

(22) Filed: Sep. 9, 2005

Related U.S. Application Data
(63) Continuation of application No. PCT/EP04/00853, filed on Jan. 30, 2004.

(30) Foreign Application Priority Data
Mar. 15, 2003 (DE) 103 11 455.6

(51) Int. Cl. B67B 7/00

(52) U.S. Cl. 81/3.07

(57) ABSTRACT

In order to simplify the insertion of the tool in the case of a coupling for a surgical rotary drive hand piece including a tool which is mounted in the hand piece and driven thereby in rotary manner and incorporating a sleeve-shaped, rotary driven seating in the hand piece into which a shank of the tool is adapted to be inserted so as to form an interlocking rotary drive means, and including at least one locking body which is adapted to be inserted radially into the interior of the seating and which, in an inserted locking position, engages in a recess in the shank and thereby secures it from axial displacement, whereas, in a radially withdrawn position, it leaves the recess and thus enables an axial displacement of the shank in the seating, it is proposed that a driver having at least one contact surface on the side thereof facing the tool and which rotates with the sleeve and is axially displaceable with respect thereto be arranged in the sleeve-shaped seating for the purposes of forming an interlocking rotary drive means, in that the driver is displaceable by the effect of a spring into a pushed-out position in which the locking body or bodies rest thereon and are thus held in their release position, in that the driver is displaceable by means of the shank of the tool resting thereon against the effect of the spring into a pushed-in position in which the locking body or bodies enter the locking position and can secure the shank of the tool from axial displacement, and in that the shank of the tool in the pushed-in position thereof secured from axial displacement by the locking body or bodies pushes the driver against the effect of the spring into the seating in such a manner that its contact surfaces rest against the contact surfaces of the tool so as to form a rotary drive means.

This application is a continuation of international application number PCT/EP2004/000853 filed on Jan. 30, 2004. The present disclosure relates to the subject matter disclosed in international application PCT/EP2004/000853 of Jan. 30, 2004 and German application number 103 11 455.6 of Mar. 15, 2003, which are incorporated herein by reference in their entirety and for all purposes.

### BACKGROUND OF THE INVENTION

The invention relates to a coupling for a surgical rotary drive hand piece including a tool which is mounted in the hand piece and driven thereby in rotary manner and incorporating a sleeve-shaped, rotary driven seating in the hand piece into which a shank of the tool is adapted to be inserted so as to form an interlocking rotary drive means, and including at least one locking body which is adapted to be inserted radially into the interior of the seating and which, in an inserted locking position, engages in a recess in the shank and thereby secures it from axial displacement, whereas, in a radially withdrawn position, it leaves the recess and thus enables an axial displacement of the shank in the seating.

Surgical rotary drive hand pieces are used for driving drills, end milling cutters or similar fast running shaft-like tools which are needed for the treatment of teeth, bone etc. Thereby, the tools must be replaceable as required and it is desirable for this to be capable of being effected by simply pushing them in and pulling them out whilst simultaneously creating or releasing a rotary connection to the rotary drive of the hand piece.

Couplings of this type are known wherein the tools are slid into a seating and then fixed in the axial direction by manual operation of a locking mechanism. This requires a separate operating step, and this can be disruptive when tools have to be changed frequently during a surgical operation.

Consequently, the object of the invention is to design a coupling in accordance with the preamble of the main Claim in such a way that the fixing of a tool that is inserted into the coupling can be effected without manual operation of a locking mechanism.

### SUMMARY OF THE INVENTION

In accordance with the invention, this object is achieved in the case of a coupling of the type described hereinabove in that a driver having at least one contact surface on the side thereof facing the tool and which rotates with the sleeve and is axially displaceable with respect thereto is arranged in the sleeve-shaped seating for the purposes of forming an interlocking rotary drive means, in that the driver is displaceable by the effect of a spring into a pushed-out position in which the locking body or bodies rest thereon and are thus held in their release position, in that the driver is displaceable by means of the shank of the tool resting thereon against the effect of the spring into a pushed-in position in which the locking body or bodies enter the locking position and can secure the shank of the tool from axial displacement, and in that the shank of the tool in the pushed-in position thereof secured from axial displacement by the locking body or bodies pushes the driver against the effect of the spring into the seating in such a manner that its contact surfaces rest against the contact surfaces of the tool so as to form a rotary drive means.

Thus, a driver having a dual function is arranged in the seating. On the one hand, this driver produces the mutually non-rotatable connection between the seating and the shank of the tool, whilst on the other hand the driver serves as an ejector for the tool inserted into the seating and as a blocking device which holds the locking bodies in the release position when a tool is not inserted in the seating. If the locking bodies are released so that they can move unhindered radially outward, then the driver pushes the tool out of the seating by the effect of the spring and is then located with respect to the locking body or bodies such that the latter can no longer enter the radially inward locking position. It is only when the driver is pushed back from this forward position by a tool being slid into the seating that the locking bodies can again be shifted radially inwardly, but even then, only if the shank of the tool is pushed in completely so that the recess in the shank is located opposite the locking bodies. In this position, the shank can then be locked in a simple manner by a radially inward displacement of the locking bodies. This could of course be effected manually, but is preferably achieved automatically by means of a spring so that manual operation of a locking mechanism becomes redundant. In the inserted and locked position of the tool, the contact surfaces of the shank and the contact surfaces of the driver are clamped against each other by the effect of the spring so that a secure rotary drive means is thereby ensured.

The contact surfaces are especially preserved if it is ensured that torque is introduced over a large-area, and this can be achieved in accordance with a preferred embodiment for example, if the respective contact surfaces of the driver and the tool engage each other with an areal contact.

However, in a modified embodiment provision could also be made for the respective contact surfaces of the driver and the tool engage each other with a line contact.

In a particularly preferred embodiment, provision is made for the contact surfaces on one part to be in the form of a lead-in funnel and on the other part to be in the form of a lead-in tip. In principle, it is possible to provide the lead-in funnel either on the shank of the tool or on the driver and, accordingly, the lead-in tip on the other respective part, however, a preferred arrangement is one wherein the lead-in tip is arranged on the shank of the tool and the lead-in funnel on the driver since the radial expansion of the tool shank can be kept low in this way. This can be of importance at the very high rotational speeds being used.

It is expedient, if, in the vicinity of their respective contact surfaces, the driver and the tool are mirror symmetrical with respect to a mirror plane which extends through the axis of rotation of the seating and through a diameter of the inserted tool. A particularly advantageous arrangement results if the seating and the tool each comprise two contact surfaces. In the case of a symmetrical arrangement, there are then two coupling locations which are inevitably adopted when the tool shank is pushed into the seating due to the arrangement in the form of a lead-in funnel.

In particular, provision can be made for the normal vectors of the two contact surfaces of the tool and/or the driver to run in parallel with each other, and in particular, to lie in one plane.

In a particularly preferred embodiment, the two contact surfaces of the driver and/or the tool are exactly or approximately V-shaped, the contact surfaces thus approaching each other in the form of a wedge shape. A particularly good aid to the insertion process and to the angular alignment between the driver and the tool shank thereby results.

In a preferred embodiment, provision is made for the contact surfaces of the driver and/or the tool to be flat. This enables them to be in contact over an area and facilitates the production process.

However, provision could also be made for the contact surfaces of the tool or the driver to have a curved contour. Hereby, the curved contour may lie in the longitudinal direction of the contact surface, i.e. in the direction of a leg of the V-shape, or else, transverse thereto. It is preferred hereby, that the contour be one wherein the contact surface is flat transverse to the longitudinal direction and curved in the longitudinal direction.

Hereby, provision may be made for the contour to be convex in the region close to the rotational axis and be set back with respect thereto in the region remote from the rotational axis. In this way, one obtains a linear imposition of the contact surfaces upon one another, especially if one of the two contact surfaces is flat and the other one is curved.

The set back region can be created for example, in that the contour is concave in the region remote from the rotational axis.

Furthermore, provision may be made for the opening angle of the lead-in funnel to be larger in the region remote from the rotational axis than it is in the region close to the rotational axis. This facilitates the insertion process and leads to the contact surfaces lying closer together in the region close to the rotational axis, i.e. there is more material available for the outermost contact surfaces.

In another embodiment, the contact surfaces are arranged to be parallel to the axis of rotation of the seating and hence, they also run in parallel with each other. A lead-in-funnel-like expansion effect can be associated with these parallel contact surfaces.

The recess in the shank of the tool accommodating the locking body can be a peripheral groove.

However, as the shank and the driver are in quite specific relative angular positions with respect to one another, provision can be made for the recess accommodating the locking body to be a straight-line groove in the outer surface of the tool which extends transversely with respect to the axis of rotation or else a depression in the outer surface of the tool which is closed at the edges thereof, in particular, in the form of a ball joint. As a result thereof, there is a substantially lesser weakening of the tool shank in the vicinity of the recess than is the case when it is in the form of a circumferential peripheral groove, and this can be of advantage especially for small diameters of the tool shank and at the necessarily high rotational speeds thereof.

In a preferred embodiment, the driver is wedge-shaped at the end thereof in the form of a lead-in funnel facing the tool. This additionally facilitates the introduction of the tool. Hereby, the wedge angle can lie between 60° and 90°, and it is preferably in the region of approximately 75°.

It is advantageous for the outer face of the driver in the seating to comprise a recess into which the locking body extends when the driver is in its pushed-out position and the spring is in its relaxed state. It is thereby ensured that the driver will not immediately release the locking bodies during the introduction of the shank and the adaptation of the angular positions of the driver and the shank, this only occurring after the introduction of the shank and the consequent adjustment of the angular position when the user exerts a stronger pressure on the tool so that the driver is pushed back against the effect of the spring whereby the locking bodies are also forced outwardly from the recesses in the outer face of the driver. Thereby, this recess is normally of very shallow depth so that this displacement of the locking bodies does not require any too great a force.

The outward displacement of the driver is preferably limited by a stop means on the seating.

Provision may be made for the driver to comprise a slot extending in parallel with its direction of displacement and through which there projects a driver pin that is fixed to the seating. Thus, the driver is connected to the seating in mutually non-rotatable manner, but is nevertheless freely displaceable in the axial direction. Moreover, the driver pin limits the axial movement of the driver and is thus effective as a stop means.

It is expedient, if the locking body in the inserted locking position engages the edge of the recess with a point or line contact, this thereby resulting in a precisely defined axial position of the tool. For example, the locking body can be a ball and the recess may have an arc-shaped contour whose radius is slightly smaller than the radius of the locking body. The spherical locking body then rests against the edge of the recess.

It is particularly advantageous, if the locking body is shifted into the locking position in resilient manner.

In principle, it is possible to provide just one locking body but it is advantageous however, to make use of a plurality of locking bodies, two for example.

It is particularly expedient if the locking bodies are balls.

The locking body can preferably be guided in displaceable manner in a radial opening of the seating.

Furthermore, it is advantageous for the purposes of the displacement of the locking body, if the seating is surrounded by a displacement sleeve incorporating a slide surface for the locking body, this preferably being spring loaded in the direction of radial insertion of the locking body.

The slide surface can be inclined over at least a partial section thereof relative to the direction of displacement of the displacement sleeve so that due to this inclination and the spring loading of the displacement sleeve, the displacement sleeve presses the locking body radially inward into its locking position in resilient manner.

The protection also extends to a tool that comprises the features which are indicated in further subordinate Claims and which enable the use thereof in the coupling in accordance with the invention.

The following description of preferred embodiments of the invention serves for a more detailed explanation in conjunction with the drawing.

### BRIEF DESCRIPTION OF THE DRAWINGS

FIG. 1: shows a longitudinal sectional view through a surgical rotary drive hand piece having a tool inserted therein;

FIG. 2: an enlarged partial sectional view of the region of the seating of the rotary drive hand piece of FIG. 1 accommodating the shank of the tool in the case where the tool is inserted and secured from axial displacement;

FIG. 3: a view similar to FIG. 2 wherein the tool is pushed out and the driver has been advanced;

FIG. 4: a plan view of the shank of a tool in contact with a driver in accordance with a first preferred embodiment;

FIG. 5: a side view of the arrangement of FIG. 4;

FIG. 6 to FIG. 11: modified embodiments of the connecting regions between the tool shank and the driver;

FIG. 12: an enlarged detailed view of the coupling region including a spherical locking body which is resting on the edge of a recess in the tool;

FIG. 13: a view similar to that of FIG. 4 utilising a wedge-shaped pointed driver and

FIG. 14: a view similar to that of FIG. 5 of the driver depicted in FIG. 13.

### DETAILED DESCRIPTION OF THE INVENTION

The hand piece 1 illustrated in the drawing comprises a cylindrical housing 2 having a connecting unit 3 on the rear face thereof and a conically tapering pointed part 4 at the opposite end thereof. With the aid of the connecting unit 3, the housing 2 is attached in a manner that is not apparent from the drawing to a drive means, for example, to an electric motor arranged in a housing.

A cylindrical seating 7 in the form of a seating sleeve 7 that is open towards the front end of the hand piece 1 is mounted in the interior of the cylindrical housing 2 by means of two ball bearings 5, 6, the end of said seating sleeve facing the connecting unit 3 being connectible in mutually non-rotatable manner and in a manner that is not apparent from the drawing to the rotary drive of the motor attached to the connecting unit 3. The seating 7 has a cylindrical interior 8 which is open towards the pointed part 4 and is closed at the opposite end thereof by a base 9. A driver 10 is inserted into the interior and connected in mutually non-rotatable manner thereto, said driver being essentially in the form of a circular cylinder which is guided in displaceable manner in the interior of the seating 7 on the inner wall thereof in the longitudinal direction of the seating. Through an elongated slot 11 in the driver 10, there projects a pin 12 which is fixed to the seating 7 and extends transversely with respect to said longitudinal direction, and which connects the driver 10 to the seating 7 in mutually non-rotatable manner on the one hand and limits the longitudinal displacement of the driver 10 on the other.

The end of a compression spring 13 facing the base 9 is supported on the driver 10 whilst the opposite end thereof is accommodated in a depression in the base 9 and hence the driver 10 is subjected to a spring force which tries to push the driver 10 out of the seating 7. In other words, the driver 10 can only be shifted in the direction of the base 9 against the effect of this compression spring 13.

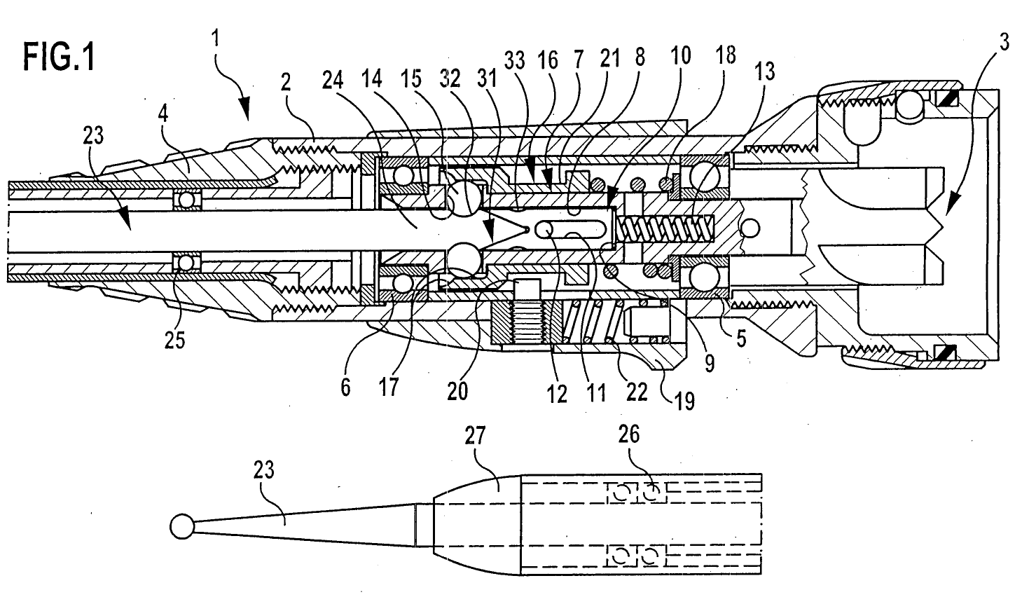

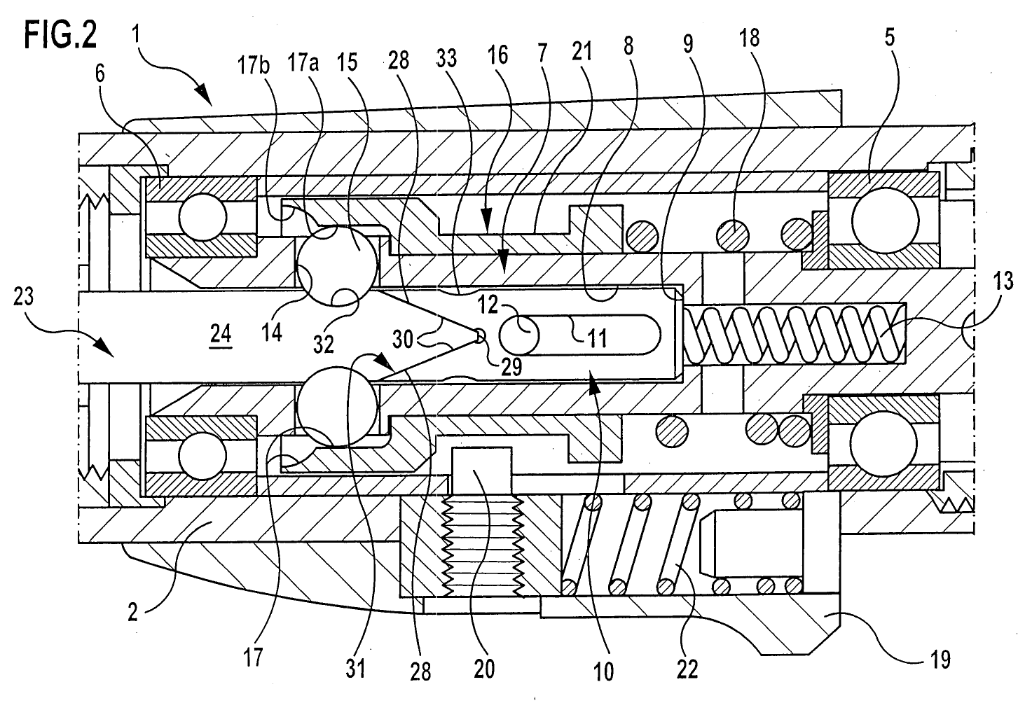

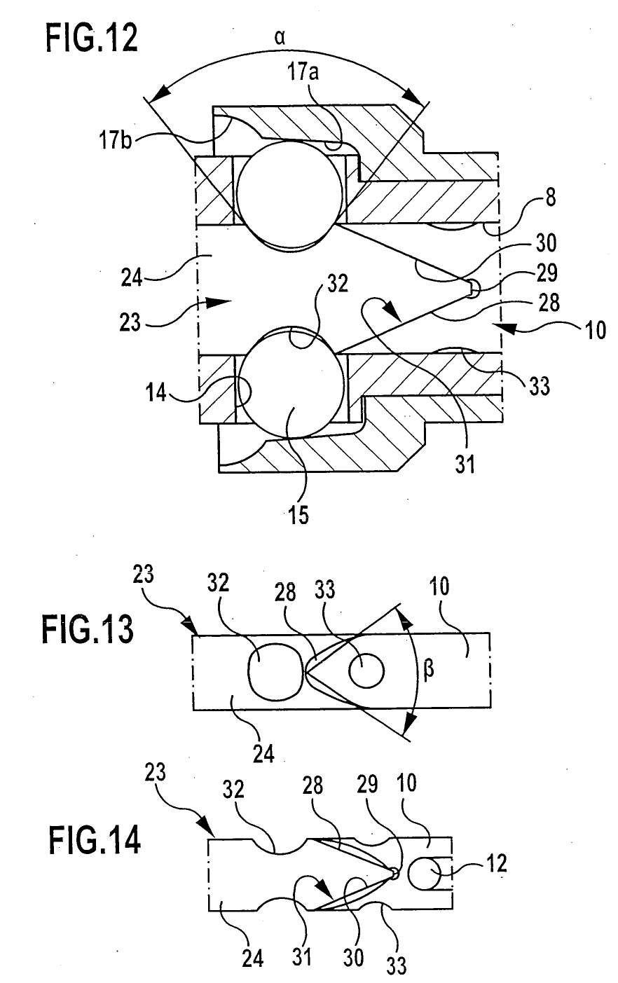

In the embodiment of FIGS. 1 to 3, the section 17a of the pressure surface 17 is in the form of a circular cylinder, whereas in the embodiment of FIG. 12 it is slightly conical so that this section is inclined with respect to the direction of displacement of the displacement sleeve 16. Consequently, the locking body 15 is also urged inwardly in its inserted locking position since the displacement sleeve 16 is pushed forward by the effect of the coil spring 18.

The insert preferably consists of a particularly tough material, for example, of hard metal.

Two channel-shaped, radial through holes 14 are located diametrically opposite one another in the wall of the seating 7 at a short distance from the front end of the driver 10 and a spherical locking body 15 is guided in radially displaceable manner in each of these through holes 14 so that the locking bodies 15 can be pushed into these through holes so as to project radially into the interior and can also be pushed out of them again.

A displacement sleeve 16 is mounted on the outer surface of the seating 7 in axially displaceable manner, said sleeve extending over the locking bodies 15 and trapping them by means of a ring-like pressure surface 17 which comprises a circular cylinder section 17a and a neighbouring curved section 17b having a dropping slope. If one displaces the displacement sleeve 16 on the seating 7 in one direction then the locking bodies 15 resting on the pressure surface 17b are shifted radially inward, whereas a displacement of the displacement sleeve in the reverse direction results in the locking bodies 15 having so much play that they can be moved radially outwardly from the interior 8 of the seating 7.

With the help of a coil spring 18 surrounding the seating 7, the displacement sleeve 16 is urged into a locking position in which it pushes the locking bodies 15 radially inward to their maximum extent. Consequently, in order to move the locking bodies 15 radially outwards, the displacement sleeve 16 must be displaced along the seating 7 against the effect of the coil spring 18.

The displacement of the displacement sleeve 16 is effected with the help of a grip member 19 which surrounds the housing 2 and is mounted thereon and which incorporates a follower pin 20 that projects into the interior of the housing through an opening in the housing 2 and enters an annular groove 21 in the outer surface of the displacement sleeve 16 which is located at this point. Hereby, the follower pin 20 normally has free-play vis a vis each of the walls of the annular groove 21 and it is held in this position by a coil spring 22 which fixes the grip member 19 in a rest position from which it can be shifted by tensioning the coil spring 22. When the grip member 19 is displaced, it comes into contact with the side wall of the annular groove 21 and thus moves the displacement sleeve 16 into the release position in which the locking bodies 15 can be moved radially outwards.

A shaft-like tool 23 is pushed into the interior 8 of the seating 7 from the open front end of the hand piece 1 through its pointed part 4, the shank 24 of the tool having an external diameter which corresponds to the internal diameter of the interior 8. This shank 24 is thereby guided in the interior 8 in a direction transverse to the longitudinal direction thereof, further guidance being provided by the ball bearings 25, 26 which are arranged in the interior of the pointed part 4 and in a sleeve-shaped extension 27 adjoined thereto.

In the embodiment illustrated in FIGS. 1 to 5, the rear end of the shank 24 comes to a point in the manner of a wedge and comprises two flat contact surfaces 28 which run together in the form of a V-shape and form a central tip 29. Hereby, the contact surfaces 28 are arranged in such a way that their normal vectors lie in a plane, said contact surfaces 28 being mirror symmetrical with respect to a centre plane of the tool 23 which extends through the axis of rotation and through a diameter of the tool 23.

These contact surfaces 28 are designed to be complementary to flat, wedge shaped or V-shaped contact surfaces 30 on the driver 10, these contact surfaces 30 forming a wedge-shaped lead-in funnel 31 for the tip 29 of the tool 23.

Two mutually oppositely located straight-line slots 32 are worked into the outer surface of the shank 24, said slots having a circular cross section whose diameter corresponds substantially to that of the spherical locking bodies 15. The two slots 32 thereby run parallel to the planes which are defined by the contact surfaces 28.

Two ball-joint-like depressions 33 of shallow depth are worked into the outer wall of the driver 10, said depressions being located diametrically opposite each other so that they are arranged directly in front of the through holes 14 when the driver 10 is displaced so that the locking bodies 15 can enter into these depressions 33. Hereby, the depth of the depression 33 is significantly smaller than the depth of the groove 32 in the shank 24 of the tool 23.

In order to be able to insert a tool 23 into the hand piece 1, the locking bodies 15 must firstly be located in the radially driven-out position, and this can be achieved in that the displacement sleeve 16 is pushed back against the effect of the coil spring 18. The locking bodies 15 can thus be pushed radially outwards, namely, by the driver 10 which is shifted into the advanced position by the effect of the compression spring 13 and the spherical locking bodies 15 are thereby displaced outwardly to such an extent that they roll or slide along its exterior. The advancing motion of the driver 10 is limited by the pin 12 which is guided in the elongated slot 11, namely, in such a manner that the depressions 33 are located exactly opposite the break-through 14 when the driver 10 is in its fully advanced position. The radially outwardly displaced locking bodies 15 rest against the arc-shaped section 17b of the pressure surface 17 of the displacement sleeve 16 and thereby prevent it from returning to the advanced position. On the other hand, the arc-shaped section 17b of the pressure surface 17 presses the locking bodies 15 radially inward into the depression 33 by the effect of the coil spring 18. Consequently, the driver 10 is not only held in its pushed-out position by the compression spring 13, but in addition, it is also held by the locking bodies 15 which engage in the depressions 33 in the manner of a resilient latching arrangement.

If one pushes the shank 24 of a tool 23 into the seating 7 from the open end, then the tip 29 of the shank 24 enters the lead-in funnel 31 of the driver 10. The contact surfaces 28 thus engage the contact surfaces 30 with areal contact, and this leads to the tool 23 twisting until the contact surfaces 28 adopt the same orientation as the contact surfaces 30. In the course of this angular adjustment, the driver 10 is fixed by the locking bodies 15 projecting into the depressions 33. Nevertheless, the user can overcome this fixing arrangement if he presses the tool 23 into the seating 7 with greater force after the angular adjustment process has terminated. The locking bodies 15 are thus pressed radially outward and thereby displace the displacement sleeve 16 further back against the effect of the coil spring 18 because they are resting against the arc-shaped section 17b of the pressure surface 17. As soon as the tool 23 has been pushed in to such an extent that the groove 32 is located opposite the through holes 14 and thus the locking bodies 15, the latter can enter the groove 32 in the radially inward direction and thereby release the displacement sleeve 16 which is shifted into the advanced position by the effect of the coil spring 18 so that the cylindrical section 17a of the pressure surface 17 now rests on the outer surface of the locking bodies 15 and thereby prevents them from being shifted radially outwardly, whereby the shank 24 of the tool 23 is then fixed in the housing 2 in the axial direction.

In this fixed position of the tool 23, the driver 10 is urged against the shank 24 by the compression spring 13 so that a reliable rotary drive effect occurs in the region of the contact surfaces 28 and 30 as a result of their laminar contact, the rotary motion of the seating 7 is thus transferred via the pin 12 to the driver 10 and from the driver 10 to the tool 23.

For the purposes of removing the tool 23, it is sufficient to pull back the displacement sleeve 16 against the effect of the coil spring 18 whereby the locking bodies 15 are released in the radial direction and the driver 10 can now be pushed forward by the effect of the compression spring 13 and hence the tool 23 is also pushed out of the seating 7. In the same way, as described above, the driver 10 then blocks the locking bodies 15 in their radially withdrawn position so that the tool can be changed in the same manner as was described above.

Thus, in addition, the driver also has the effect of an ejector for the tool 23 accommodated in the seating 7.

In the case of the embodiment illustrated in FIGS. 1 to 5, the contact surfaces 28 and 30 are flat and engage each other with areal contact, the tip 29 and the lead-in funnel 31 are thus complementary to one another.

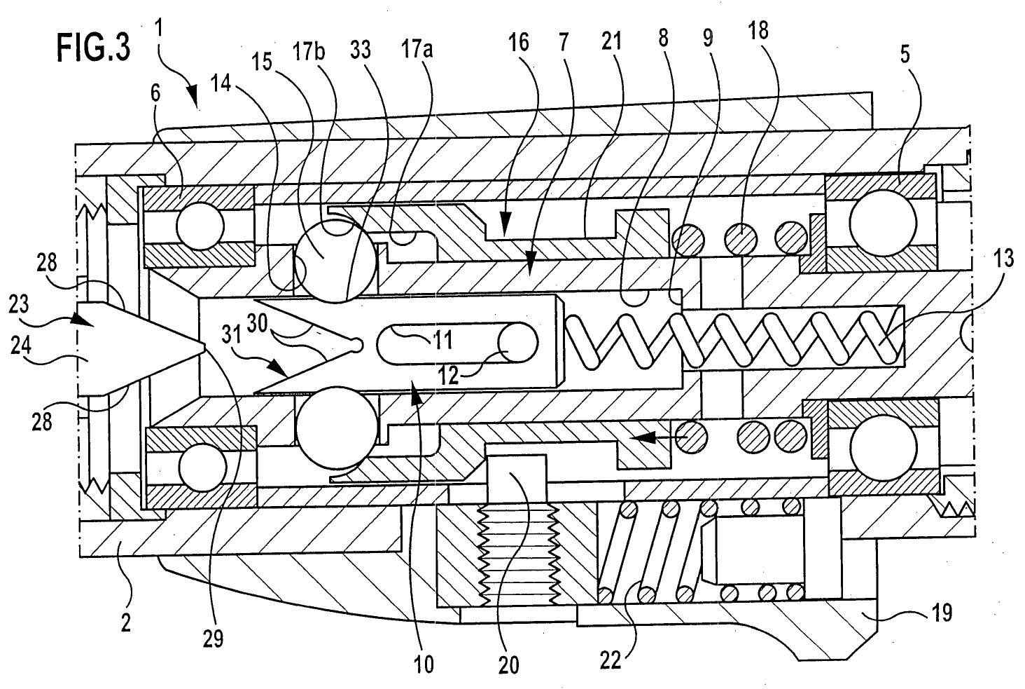

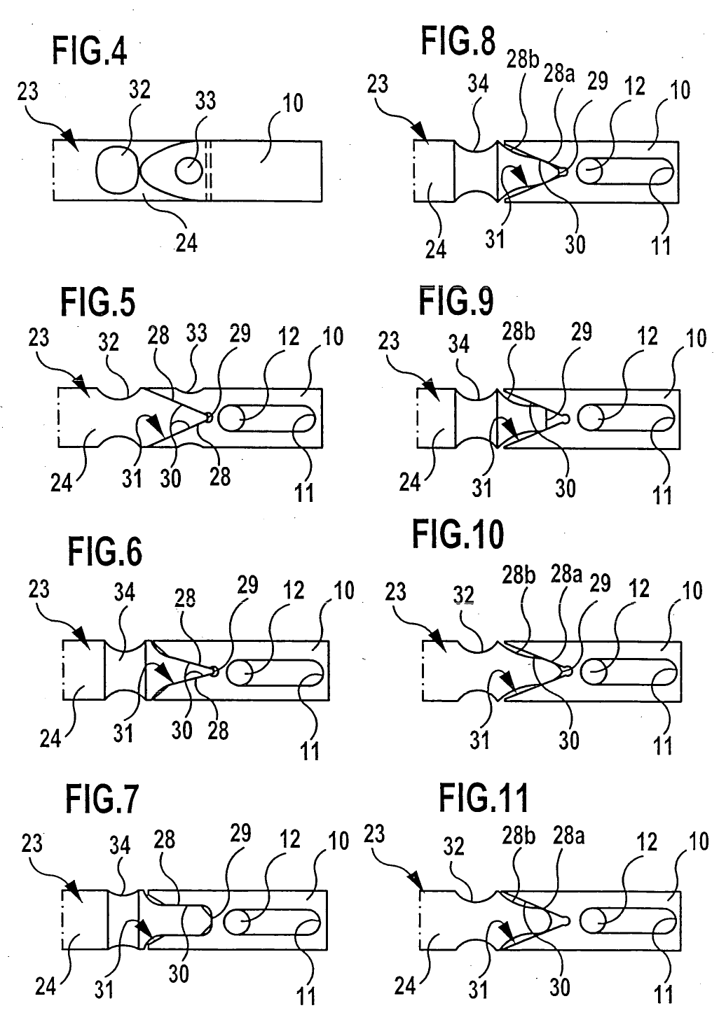

Different geometrical arrangements are also possible in this area of contact, some possible modifications being illustrated in exemplary manner in FIGS. 6 to 11.

In the embodiment of FIG. 6, the mutually diametrically oppositely located straight-line grooves 32 are replaced by a peripheral annular groove 34, and in addition, the lead-in funnel 31 of the driver 10 is widened at the lead-in-in end thereof, i.e. it has a larger wedge angle. Accordingly, in the embodiment of FIG. 6, the contact surfaces 28 of the tip 29 are also widened in this region by virtue of an arc-shaped contour so that there is no longer a full area contact in this region. In this embodiment, the rotary drive effect only occurs in that region of the tip 29 and the driver 10 which is close to the rotational axis.

In the embodiment of FIG. 7, a similar arrangement is selected but with the difference that the contact surfaces 28 and the complementary contact surfaces 30 are not arranged in the form of a wedge or a V-shape but rather, are mutually spaced and run in parallel with one another, namely, parallel to the axis of rotation of the tool 23.

In the cases depicted in FIGS. 1 to 7, the contact surfaces 28 and 30 are formed in such a way that they fit together with areal contact in the coupled state and thus ensure there is a large area for the torque transmission process.

By contrast, in the case of the embodiments of FIGS. 8 to 11, there is a line contact between the contact surfaces due to the shape of the contact surfaces.

Whereas with these constructions the contact surfaces 30 of the driver are likewise in the form of flat, wedge shaped or V-shaped surfaces, the contact surfaces 28 of the shank 24 have curved contours in these embodiments, namely, curved in the longitudinal direction of the V-shaped arms although transversely thereto, the contact surfaces 28 being flat.

In the embodiment of FIG. 8, the contact surface 28 comprises a convex portion 28a in the region close to the rotational axis and a concave portion 28b in the region remote from the rotational axis so that contact only occurs in the convex portion 28a and this contact is in the form of a line.

In the embodiment of FIG. 9, the contact surface 28 is concave for the most part, it being chamfered or convex only in the end portion near the tip so that contact with the contact surface 30 only occurs over a very small boundary region.

Similar contours to those of FIG. 8 are selected for the embodiments of FIGS. 10 and 11, these embodiments however do not comprise an annular groove 34, but rather, mutually opposite grooves 32.

1. A coupling for a surgical rotary drive hand piece, said hand piece including:
a tool which is mounted therein and driven thereby in a rotary manner, said hand piece incorporating a sleeve-shaped rotary driven seating into which a shank of the tool is adapted to be inserted so as to form an interlocking rotary drive means, and
at least one locking body which is adapted to be inserted radially into the interior of the seating and which (i) in an inserted locking position, engages in a recess in the shank and thereby secures it from axial displacement, and (ii) in a radially withdrawn position, leaves the recess and thus enables an axial displacement of the shank in the seating,
wherein:
a driver is arranged in the sleeve-shaped seating to form said interlocking rotary drive means, said driver having at least one contact surface on a side thereof facing the tool and being rotatable with and axially displaceable with respect to the sleeve-shaped seating,
the driver being displaceable by a spring into a pushed-out position in which the at least one locking body rests thereon to be held in a release position,
the driver being displaceable by means of the shank of the tool resting thereon against the effect of the spring into a pushed-in position in which the at least one locking body enters the locking position and can secure the shank of the tool from axial displacement, and
the shank of the tool in the pushed-in position secured from axial displacement by the at least one locking body pushes the driver against the effect of the spring into the seating in such a manner that its contact surfaces rest against the contact surfaces of the tool so as to form said rotary drive means.

2. A coupling in accordance with claim 1, wherein the respective contact surfaces of the driver and the tool engage each other with an areal contact.

3. A coupling in accordance with claim 1, wherein the respective contact surfaces of the driver and the tool engage each other with a line contact.

4. A coupling in accordance with claim 1, wherein the contact surfaces on one part are in the form of a lead-in funnel and on the other part are in the form of a lead-in tip

5. A coupling in accordance with claim 1, wherein, in the vicinity of their respective contact surfaces, the driver and the tool are mirror symmetrical with respect to a mirror plane which extends through the axis of rotation of the seating and through a diameter of the inserted tool.

6. A coupling in accordance with claim 1, wherein the driver and the tool each comprise two contact surfaces.

7. A coupling in accordance with claim 6, wherein the respective normal vectors of the two contact surfaces and of the tool and/or the driver run in parallel with each other.

8. A coupling in accordance with claim 6, wherein the respective two contact surfaces of the driver and/or the tool are arranged to be V-shaped.

9. A coupling in accordance with claim 1, wherein the respective contact surfaces of the driver and/or the tool are flat.

10. A coupling in accordance with claim 1, wherein the contact surfaces of the tool or the driver have a curved contour.

11. A coupling in accordance with claim 10, wherein the contour is convex in the region close to the rotational axis and is set back with respect thereto in the region remote from the rotational axis.

12. A coupling in accordance with claim 11, wherein the contour is concave in the region remote from the rotational axis.

13. A coupling in accordance with claim 4, wherein the opening angle of the lead-in funnel is larger in the region remote from the rotational axis than in the region close to the rotational axis.

14. A coupling in accordance with claim 1, wherein the contact surfaces are arranged in parallel with the axis of rotation of the seating.

15. A coupling in accordance with claim 4, wherein the driver is wedge-shaped at the lead-in funnel shaped end thereof facing the tool.

16. A coupling in accordance with claim 15, wherein the wedge angle (β) of the driver lies between 60 and 90°.

17. A coupling in accordance with claim 1, wherein the recess accommodating the locking body is a peripheral groove.

18. A coupling in accordance with claim 1, wherein the recess accommodating the locking body is a straight-line groove in the outer surface of the tool which extends transversely with respect to the axis of rotation.

19. A coupling in accordance with claim 1, wherein the recess is a depression in the outer surface of the tool which is closed at the edges thereof.

20. A coupling in accordance with claim 19, wherein the recess is in the form of a ball joint.

21. A coupling in accordance with claim 1, wherein, in the inserted locking position thereof, the locking body engages the edge of the recess with a point or line contact.

22. A coupling in accordance with claim 21, wherein the locking body is a ball and the recess has an arc-shaped contour whose radius is slightly smaller than the radius of the locking body.

23. A coupling in accordance with claim 1, wherein the driver in the seating comprises a recess in its outer surface into which the locking body extends when the driver is in its pushed-out position with the spring in its relaxed state.

24. A coupling in accordance with claim 1, wherein the outward displacement of the driver is limited by a stop means on the seating.

25. A coupling in accordance with claim 1, wherein the driver comprises a slot which extends in parallel with its direction of displacement and through which there projects a driver pin that is fixed to the seating.

26. A coupling in accordance with claim 1, wherein the locking body is shifted into the locking position in resilient manner.

27. A coupling in accordance with claim 1, wherein a plurality of locking bodies are provided.

28. A coupling in accordance with claim 1, wherein the locking body or bodies are balls.

29. A coupling in accordance with claim 1, wherein the locking body is guided in displaceable manner in a radial opening of the seating.

30. A coupling in accordance with claim 1, wherein, for the purposes of the displacement of the locking body, the seating is surrounded by a displacement sleeve incorporating a slide surface for the locking body and is spring loaded in the direction of radial insertion of the locking body.

31. A coupling in accordance with claim 30, wherein the slide surface is inclined over at least a partial section thereof relative to the direction of displacement of the displacement sleeve.

32. A tool for use in a coupling in accordance with claim 1, wherein:
the shank of said tool comprises contact surfaces for making contact with contact surfaces of the driver in mutually non-rotatable manner and which merge into a lead-in tip, and
at least one recess for a locking body adjoins the contact surfaces on the sides thereof remote from the lead-in tip.

33. A tool in accordance with claim 32, wherein, in the vicinity of its contact surfaces, it is mirror symmetrical with respect to a mirror plane which extends through the axis of rotation of the tool and through a diameter of the inserted tool.

34. A tool in accordance with claim 32, wherein each tool comprises two contact surfaces.

35. A tool in accordance with claim 32, wherein the normal vectors of the two contact surfaces of the tool run in parallel with one another.

36. A tool in accordance with claim 34, wherein the two contact surfaces of the tool are arranged in the form of a V-shape.

37. A tool in accordance with claim 32, wherein the contact surfaces are flat.

38. A tool in accordance claim 32, wherein the contact surfaces have a curved contour.

39. A tool in accordance with claim 38, wherein the contour is convex in the region close to the rotational axis and is set back with respect thereto in the region remote from the rotational axis.

40. A tool in accordance with claim 38, wherein the contour is concave in the region remote from the rotational axis.

41. A tool in accordance with claim 33, wherein the contact surfaces are arranged in parallel with respect to the axis of rotation of the tool.

42. A tool in accordance with claim 32, wherein the recess accommodating the locking body is a peripheral groove.

43. A tool in accordance with claim 32, wherein the recess accommodating the locking body is a straight-line groove in the outer surface of the tool which extends transversely with respect to the axis of rotation.

44. A tool in accordance with claim 32, wherein the recess is a depression in the outer surface of the tool which is closed at the edges thereof.

45. A tool in accordance with claim 44, wherein the depression is in the form of a ball joint.
